(19) United States
(12) Patent Application Publication
(10) Pub. No.: US 2010/0224126 A1
(43) Pub. Date: Sep. 9, 2010

(54) Electrostatic flocking device

(76) Inventor: Boris Kriman, Freeport (BS)

Correspondence Address: Ilya Zborovsky, 6 Schoolhouse Way, Dix Hills, NY, 11746, US

(21) Appl. No.: 12/380,658

(22) Filed: Mar. 3, 2009

(51) Int. Cl. B05B 5/025

(52) U.S. Cl. 118/621

(57) ABSTRACT

A portable electrostatic flocking device, has a housing configured as a wand, an electrostatic generator configured as a Van de Graaf generator located in said wand, and a container for accommodating flock and having a permeable wall.

### BACKGROUND OF THE INVENTION

The present invention relates to electrostatic flocking devices.

Flocking devices are used to produce fabric-like, velvet, nap surface. Some of these devices are disclosed for example in U.S. Pat. No. 4,905,627, and in Chinese patent documents CN 2189495 and CN 2363798.

The known devices usually include an electronic source of high voltage, and a wand for application of flock. A container for flock is attached to an upper end of the wand. The flock inside the container is kept by means of a plastic net. An electrode is located inside the container and formed for example as a metal rod or plate, such that a contact with the electrode provides charging of flock. The device can be connected with a source of high voltage by means of a high voltage cable as shown in FIG. 1.

There are also portable flocking devices, in which a source of high voltage is located directly in a casing of the wand, and a power supply of the source is provided from batteries as shown in FIG. 2. Such flocking devices are expensive since they contain the electronic source of high voltage and also dangerous due to possible electric shock.

It is therefore believed that the existing flocking devices can be improved.

### SUMMARY OF THE INVENTION

Accordingly, it is an object of the present invention to provide an electrostatic flocking device, which is a further improvement of the existing flocking devices.

More particularly, it is an object of the present invention to provide an electrostatic flocking device which has a simple construction, is less expensive, and also safe during the operation.

It is also an object of the present invention to provide such electrostatic flocking device which due to the above mentioned advantages can be used as a toy for flocking of figures, picture frames, cards, for providing text and pictures on clothes, and also for applying flock directly to person's skin.

In keeping with these objects and with others which will become apparent hereinafter, one feature of the present invention resides, briefly stated, in a portable electrostatic flocking device, comprising a housing configured as a wand, an electrostatic generator configured as a Van de Graaf generator located in said wand; and a container for accommodating flock and having a permeable wall.

The permeable wall can be formed as a net-shaped cover. The container and the permeable wall can be composed of a plastic material.

The generator can have a charge accumulating element which is composed of an electrically conductive material with a high specific electrical resistance.

Also a metal electrode can be located in the container and connected with a brush of the generator by an electrical conductor.

The generator can have a charge accumulating element which is composed of a cardboard.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1 and 2 are views showing prior art flocking devices;

FIG. 3 is a perspective view of an electrostatic flocking device in accordance with the present invention;

FIGS. 4a and 4b show a section of a front view and a section of a side view of the inventive electrostatic flocking device; and

FIG. 5 is a view showing a process of application on flock of a surface with an electrostatic flocking device.

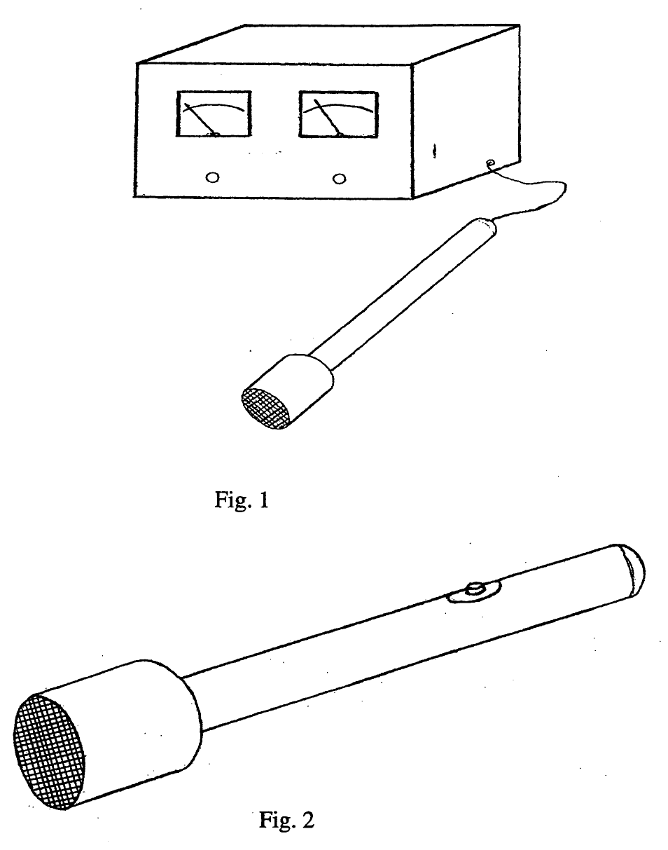

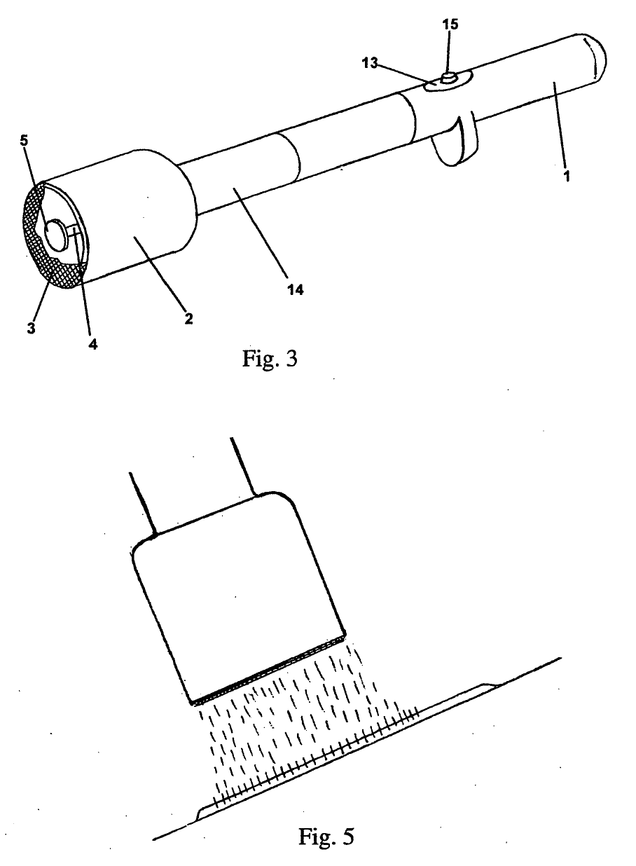

### DESCRIPTION OF THE PREFERRED EMBODIMENTS

An electrostatic flocking device in accordance with the present invention is formed as a wand with a handle 1, and a container 2 for flock attached to the upper end of the handle. The container is formed as a cup composed of a plastic material and covered with a net 3 for retaining the flock.

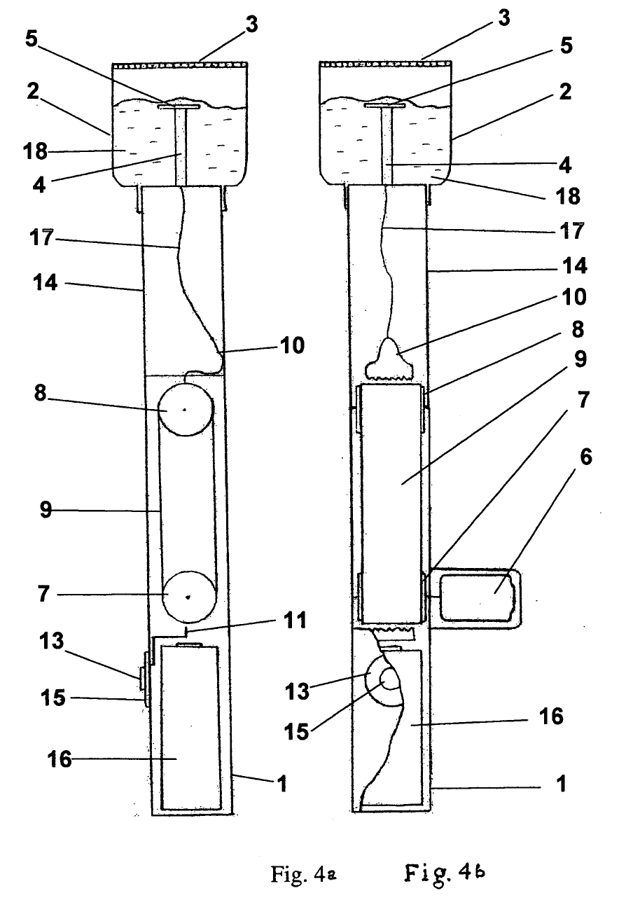

A metal rod 4 with a metal disk 5 connected to it on top is located inside the container. An electrostatic generator is located in the housing of the wand. The generator is configured as a Van de Graaf generator shown in FIG. 4. It includes an electric motor 6 and two pulleys 7 and 8 which are connected with one another by a belt 9. The pulley 7 is composed of a dielectric material and arranged on a shaft of the electric motor 6, and the pulley 9 is composed of metal.

The generator also has two brushes 10 and 11 for taking electric charges. They are formed as sharp-edge plates arranged perpendicularly to an external surface of a belt transmission 12. One brush 11 is connected with a metal disk 13 on the housing of the generator and located near the dielectric pulley 7. The other brush 10 is connected with an inner surface of a charge accumulating element 14 and located near the metal pulley 8.

The element 14 for accumulating electric charges is formed as removable tube composed of an electrically conductive material with a high specific electrical resistance. It is arranged on the end of the wand which is opposite to the handle 1. A button 15 is provided on the handle 1, and an electrically conductive disk 13 is located under it. A battery 16 is accommodated in the handle. The metal rod arranged in a bottom of the container 2 is connected by a cable extending through the tube of the element 14 for accumulation of charges, to the upper brush of the Van de Graaf generator.

The electrostatic flocking device in accordance with the present invention operates in the following manner. When the button 15 is pressed, the battery 16 supplies current to the electric motor 6 which rotates the pulley 7 and correspondingly the belt 9. During pressing of the button 15 simultaneously a contact of a finger of a user's hand with the electrically conductive disk 13 connected to the brush 11 is provided, which causes its grounding. Since the belt 9 is composed of rubber, and the pulley 7 is composed of a dielectric plastic material, for example of silicon, when the belt 9 is brought into contact with it the belt is charged positively while the pulley 7 is charged negatively.

It is important that the concentration of charge of the pulley 7 is significantly higher than on the belt 9, and thereby near the pulley 7 at the lower brush 11 a field of negatively charged lower pulley is dominating. This field has a strength which is especially high near the sharp edge of the brush. The movable negatively charged electrons leaves the sharp edge due to the electrostatic repelling from the similarly charged roll. As a result the brush 11 is charged positively. In addition, an ionization of air near its sharp edge takes place. Molecules of air loose electrons and are charged positively. The electrons are attracted to the positive brush 11, while positive ions are attracted to the negatively charged pulley 7. Since the belt 9 is located on their way, they are deposited on its outer surface and moved toward the upper pulley 8.

Near the upper pulley 8 the positive charges on the belt attract negative electrons in the brush 10. An electric field is generated, which causes ionization of air, and as a result positive ions of air are attracted to the brush 10, while electrons are attracted to the belt 9. Positive charge is obtained by the brush and is immediately transferred to the outer surface of the hollow charge accumulating element 14. As a result, on the tubular accumulating element, a sufficiently great electric charge is accumulated, while a strong electric field is located around it. Due to the high specific electrical resistance of the material of the charge accumulating element, touching it does not cause any unpleasant feelings, since the electrical charges flows out from it slowly.

At the same time particles of flock 18 accommodated in the container 2 also obtain an electrical charge which is supplied to the brush 10 through the cable 17 to the rod 5 and the disk, with which the flock particles are in direct contact. When the container with flock approaches any conductive ground surface 19, between the charge accumulating surface a directional electrical field is created as shown in FIG. 5. Under its action, the particles of flock pass through the net from the container and move toward the surface 19. The surface is covered with an adhesive substance 20 which is provisionally used during flocking. The particles of flock are usually fibers with the length of 0.5-5 mm. Under the action of the electric field they move along its power lines. As a result the fibers are placed on the surface uniformly and exactly perpendicular to it. After drying and cleaning from excessive quantity of flock, the surface obtains an attractive appearance and resembles velvet or plush. During flocking of electrically conductive surfaces of metal, wood, paper, fabric, it is necessary to provide grounding of these surfaces. For satisfactory flocking it suffices to provide a contact of the surface with a user's body.

During flocking of plastic materials which are dielectric, grounding is provided either by preliminarily applied grounding material, or by location under the flocking surface of the electrically conductive sheath which is connected with a user's body. Since during the flocking process the user as a rule holds the flocking device with one hand, and keeps a work piece to be flocked in another hand, the contact of the work piece with the user's body is provided automatically.

The quality of flocking substantially depends on the strength of the generated electric field, and the strength of the generated electric field depends on the charge the charge accumulating element of the flocking device. Increase in the size of the charge accumulating element leads to an increase of its electrical capacity and a level of the accumulated electrical charge. Since the tube in the inventive device is immovable, therefore by selecting of the tube with a corresponding size, it is possible to regulate required conditions of the flocking processes.

It will be understood that each of the elements described above, or two or more together, may also find a useful application in other types of constructions differing from the type described above.

While the invention has been illustrated and described as embodied in an electrostatic flocking device, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A portable electrostatic flocking device, comprising a housing configured as a wand; an electrostatic generator configured as a Van de Graaf generator located in said wand; and a container for accommodating flock and having a permeable wall.

2. A portable electrostatic flocking device as defined in claim 1, wherein said permeable wall is formed as a net-shaped cover.

3. A portable electrostatic flocking device as defined in claim 1, wherein said container and said permeable wall are composed of a plastic material.

4. A portable electrostatic flocking device as defined in claim 1, wherein said generator has a charge accumulating element which is composed of an electrically conductive material with a high specific electrical resistance.

5. A portable electrostatic flocking device as defined in claim 1, and further comprising a metal electrode located in said container and connected with a brush of said generator by an electrical conductor.

6. A portable electrostatic flocking device as defined in claim 1, wherein said generator has a charge accumulating element which is composed of a material selected from the group consisting of cardboard paper, and electrically conductive plastic.

7. A portable electrostatic flocking device as defined in claim 1, wherein and charge accumulating element is formed as a removable element.
